(19) United States
(12) Patent Application Publication
(10) Pub. No.: US 2014/0204973 A1
(43) Pub. Date: Jul. 24, 2014

(54) TEMPERATURE MEASURING SYSTEM OF ELECTRIC MOTOR HAVING HOLDING MEMBER HOLDING COIL END

(71) Applicant: FANUC CORPORATION, Yamanashi (JP)

(72) Inventors: Shinichi Kinoshita, Yamanashi (JP); Yamato Mishima, Yamanashi (JP)

(73) Assignee: FANUC CORPORATION, Yamanashi (JP)

(21) Appl. No.: 14/157,660

(22) Filed: Jan. 17, 2014

(30) Foreign Application Priority Data
Jan. 18, 2013 (JP) 2013-007680

(51) Int. Cl. G01K 13/00

(52) U.S. Cl. CPC G01K 13/00
USPC 374/152

(57) ABSTRACT

A temperature measuring system of an electric motor, including an electroconductive holding member holding a coil end of an end of a stator coil comprised of a winding wire wound around a stator core, a resistance measuring part measuring a resistance of the holding member, and a temperature calculating part calculating a temperature of the winding wire based on a resistance value measured by the resistance measuring part.

### BACKGROUND OF THE INVENTION

1. Field of the Invention

The present invention relates to a temperature measuring system of an electric motor which measures the temperature of a winding wire, an electric motor, and a temperature measuring method of an electric motor.

2. Description of the Related Art

As this type of temperature measuring system, for example, the systems described in Japanese Patent Publication No. 2004-336920A (JP2004-336920A) and Japanese Patent Publication No. 2005-502297A (JP2005-502297A) are known. In the system described in JP2004-336920A, a coil used for measuring temperature is wound in the slots of the stator, the value of the current of the coil is detected, an internal resistance value of the coil is detected based on the detected value of that current, and the temperature near the coil wound in the slots is calculated based on the internal resistance value. In the system described in JP2005-502297A, an additional conductor is embedded in the coil of the stator, the electrical resistance of the additional conductor is measured, and the temperature of the winding is estimated from the change in that resistance value.

However, in the system described in JP2004-336920A, it is necessary to secure space for winding the coil used for measuring temperature in the slots of the stator. In the system described in JP2005-502297A, it is necessary to secure space for embedding the additional conductor in the coil of the stator. That is, in both of the systems described in JP2004-336920A and JP2005-502297A, new space is required in the stator for measuring the temperature of the winding wire. The configuration of the electric motor therefore became more complicated.

### SUMMARY OF INVENTION

A temperature measuring system of an electric motor of one aspect of the present invention includes an electroconductive holding member holding a coil end of an end of a stator coil comprised of a winding wire wound around a stator core, a resistance measuring part measuring a resistance of the holding member, and a temperature calculating part calculating a temperature of the winding wire based on a resistance value measured by the resistance measuring part.

Further, an electric motor of another aspect of the present invention includes the above temperature measuring system of an electric motor.

Furthermore, a temperature measurement method of an electric motor of another aspect of the present invention includes holding a coil end of an end of a stator coil comprised of a winding wire wound around a stator core, by an electroconductive holding member, measuring a resistance of the holding member, and calculating a temperature of the winding wire based on a measured resistance value.

### BRIEF DESCRIPTION OF THE DRAWINGS

The objects, features, and advantages of the present invention will become clearer from the following description of embodiments in relation to the attached drawings. In the attached drawings,

FIG. 1 is a perspective view of an electric motor which has a temperature measuring device according to a first embodiment of the present invention,

FIG. 2 is a front view which shows the internal configuration of an electric motor according to the first embodiment of the present invention,

FIG. 3 is a cross-sectional view cut along the line III-III of FIG. 2,

FIG. 4 is a cross-sectional view of a clip of FIG. 2,

FIG. 5 is a block diagram which shows the configuration of a control device of FIG. 1,

FIG. 6 is a front view which shows the configuration of an electric motor according to a second embodiment of the present invention, and

FIG. 7 is a view along the arrow VII of FIG. 6.

### DETAILED DESCRIPTION

### First Embodiment

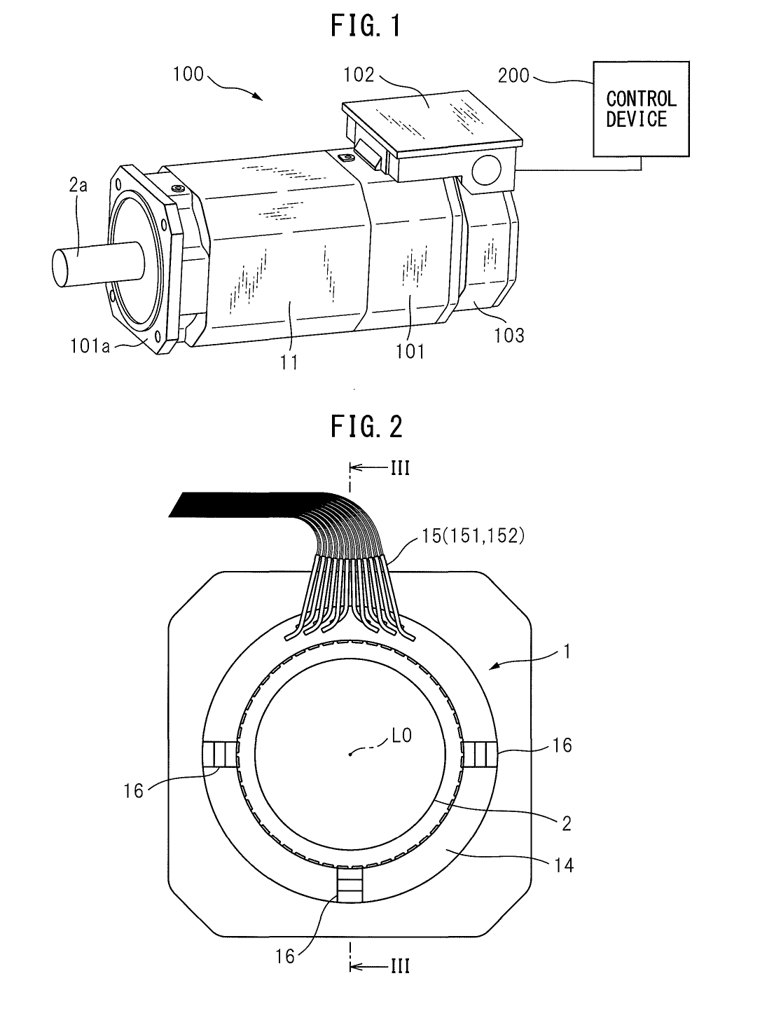

Below, referring to FIG. 1 to FIG. 5, a temperature measuring system of an electric motor according to a first embodiment of the present invention will be explained. FIG. 1 is a perspective view of an electric motor 100 which has a temperature measuring system according to the first embodiment. The electric motor 100, for example, is a three-phase induction motor. The electric motor 100 is provided with a cover 101 which covers the surroundings of later explained coil ends 14. At one end of the cover 101, a terminal box 102 and fan 103 are provided. The cover 101 is shaped so as to generally match the outer shape of a later explained stator core 11. The electric motor 100 is supplied with motor drive current, etc. from a control device 200 through the terminal box 102. At the end part of the electric motor 100 at the opposite side to the cover 101, a flange part 101a used for attaching the electric motor is provided. A motor output shaft 2a sticks out from the flange part 101a.

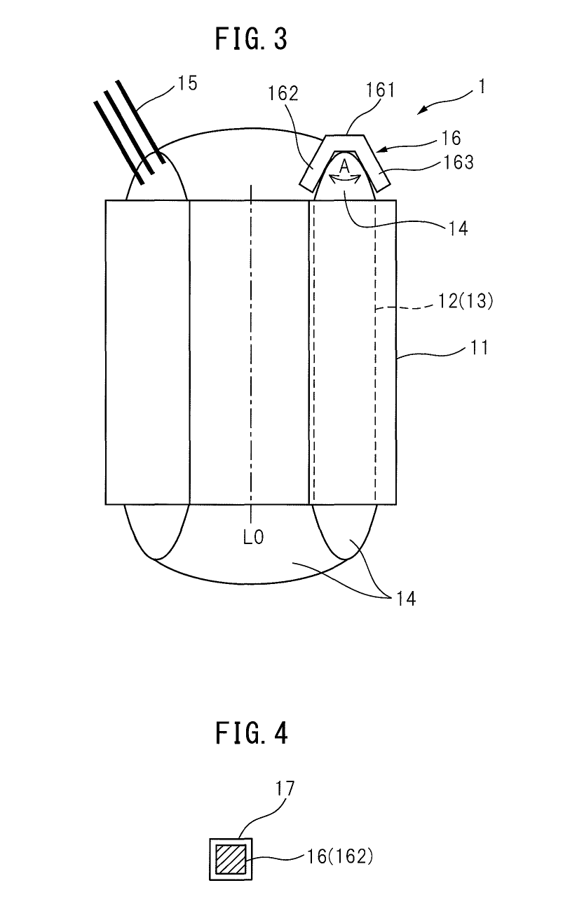

FIG. 2 is a front view which shows the internal configuration of the electric motor 100 according to the first embodiment. In FIG. 2, illustration of the cover 101, terminal box 102, and fan 103 which are shown in FIG. 1 is omitted. As shown in FIG. 2, the electric motor 100 has a stator 1 and a rotor 2 which is supported rotatably at the inside of the stator 1 about an axial line L0. FIG. 3 is a cross-sectional view cut along the line III-III of FIG. 2. In FIG. 3, illustration of the rotor 2 is omitted and mainly the configuration of the stator 1 is shown. As shown in FIGS. 2 and 3, the stator 1 has a substantially cylindrically shaped stator core 11 and a stator coil 12 which is attached to the stator core 11. The stator coil 12 is formed by winding a winding wire 13 in the slots of the stator core 11.

The stator coil 12 has coil ends 14 at both end portions in the axial direction of the stator core 11. From the coil ends 14, pluralities of cables 15 extend at predetermined phases in the circumferential direction. The end portions of the cables 15 are connected to the terminal box 102 (FIG. 1). The cables 15 include drive wires 151 which are connected to the winding wire 13, later explained signal wires 152, etc.

At the coil ends 14, pluralities of clips 16 are attached in the circumferential direction so as not to interfere with the cables 15. The coil ends 14 are held by the clips 16 in a predetermined shape. In FIGS. 2 and 3, only the coil end 14 at one end side in the axial direction is held by the clips 16. However, the coil ends 14 at both ends in the axial direction may be held by the clips 16.

As shown in FIG. 3, each clip 16 has a base end part 161 and a pair of gripping parts 162, 163 which extend from the base end part 161 and forms a substantially V-shape as a whole. The pair of gripping parts 162, 163 can open and close in the arrow A direction about the base end part 161 by elastic deformation. The coil end 14 is gripped by the gripping parts 162, 163.

The clip 16 is comprised of a material which has electroconductivity (electroconductive member). FIG. 4 is a cross-sectional view of a clip 16 (for example, gripping part 162). As shown in FIG. 4, the clip 16 is covered over its entire circumference by an insulation coating 17. The clip 16 is therefore insulated from the coil end 14.

The clip 16 contacts the coil end 14. The temperature of the clip 16 and the temperature of the winding wire 13 which forms part of the coil end 14 have a predetermined correlation. That is, if the temperature of the winding wire 13 rises, the heat is transferred to the clip 16 whereby the clip 16 rises in temperature. Further, if the clip 16 rises in temperature, the clip 16 also rises in electrical resistance value. Considering this point, in the present embodiment, the temperature of the clip 16 is measured from the electrical resistance value of the clip 16 and the temperature of the winding wire 13 is determined based on the temperature of the clip 16. In order to measure the electrical resistance of the clip 16, a signal wire 152 used for measuring the resistance is connected to the clip 16 (for example, the single clip 16). Through this signal wire 152 and terminal box 102, the control device 200 (FIG. 1) receives as input the signal (current) from the clip 16.

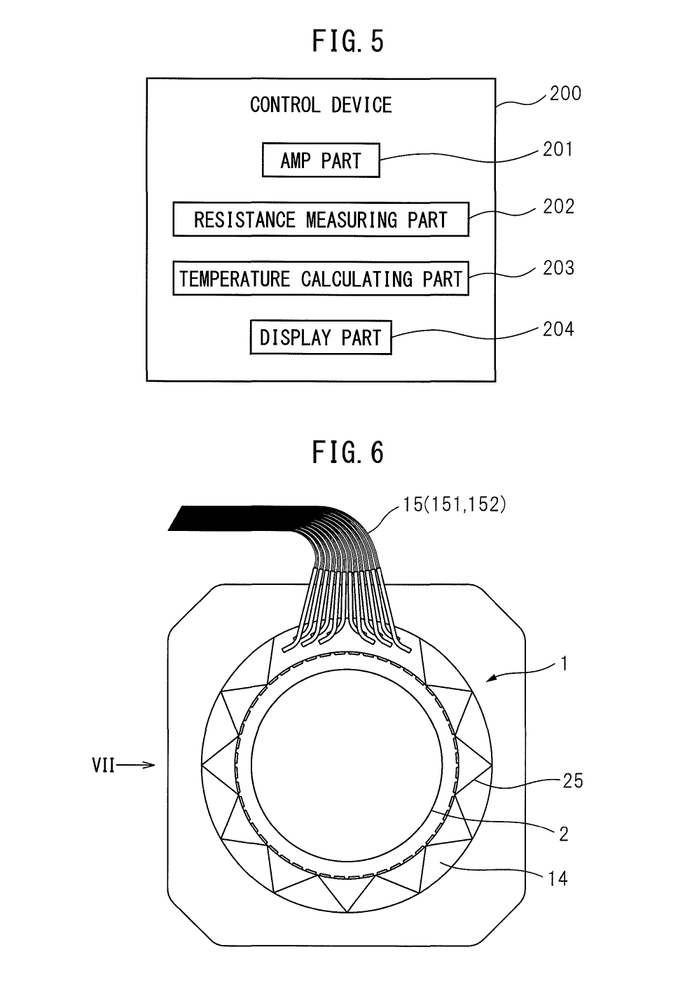

FIG. 5 is a block diagram which shows the configuration of the control device 200. The control device 200 includes an amp part 201, a resistance measuring part 202, a temperature calculating part 203, and a display part 204.

The amp part 201 outputs a motor drive current corresponding to a motor drive command to the electric motor 100. The resistance measuring part 202 is composed of, for example, an ohmmeter and measures the resistance of a clip 16 based on a signal from the clip 16 input through the signal wire 152.

The temperature calculating part 203 calculates the temperature of the winding wire 13 based on the resistance value measured by the resistance measuring part 202. For example, the relationship between the resistance value of the clip 16 and the temperature of the clip 16 and the relationship between the temperature of the clip 16 and the temperature of the winding wire 13 are determined in advance. These relationships are used to determine the temperature of the clip 16 from the resistance value of the clip 16 and, further, to determine the temperature of the winding 13 from the temperature of the clip 16. It is also possible to determine in advance the relationship between the resistance value of the clip 16 and the temperature of the winding wire 13 and directly determine the temperature of the winding wire 13 from the resistance value of the clip 16. It is also possible to define the resistance value of the clip 16 (reference resistance value) at a reference temperature (for example, ordinary temperature) in advance, compare this reference resistance value and a detected resistance value, and calculate the rise in temperature of the winding wire 13 from the change of the resistance value.

The display part 204 has a display monitor and displays the temperature of the winding wire 13 calculated by the temperature calculating part 203 on the display monitor. Due to this, the user can obtain a grasp of whether the temperature of the winding wire 13 is in a normal range. When the temperature of the winding wire 13 becomes a predetermined temperature or more, the display part 204 may output an alarm.

In the above first embodiment, a coil end 14 at the end of the stator coil 12 comprised of a winding wire 13 wound around a stator core 11 is held by electroconductive clips 16, the resistance of a clip 16 is measured by a resistance measuring part 202, and the temperature of the winding wire 13 is calculated by the temperature calculating part 203 based on the measured resistance value. With this configuration, it is not necessary to provide the stator 1 with new space for measuring the temperature of the winding wire 13. Therefore, it is possible to streamline the configuration of the stator 1 and prevent enlargement of the stator 1. Further, compared with when providing a temperature sensor, etc. at the coil end 14, it is possible to reduce the costs. The clips 16 are configured to be able to open and close, so it is possible to hold the coil end 14 by the elastic force of the clips 16. Therefore, attachment of the clips 16 to the coil end 14 also is easy.

### Second Embodiment

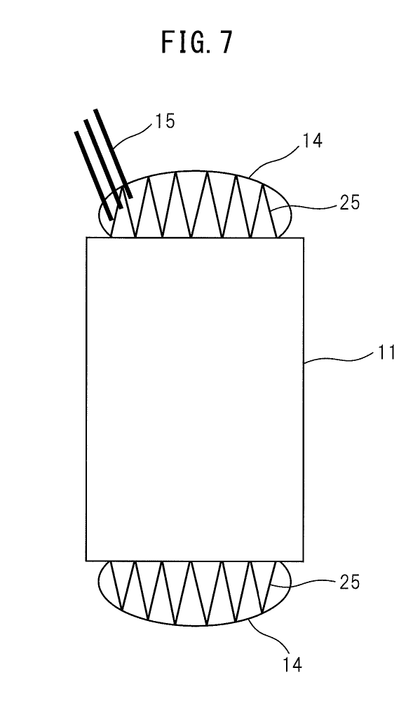

Referring to FIGS. 6 and 7, a second embodiment of the present invention will be explained. Below, the points of difference from the first embodiment will mainly be explained. The second embodiment differs from the first embodiment in the configuration of the holding member which holds a coil end 14. That is, in the first embodiment, the coil ends 14 are made to be held by the clips 16, but in the second embodiment, they are held by binding wires.

FIG. 6 is a front view which shows the configuration of an electric motor 100 according to the second embodiment, while FIG. 7 is a side view (view along arrow VII of FIG. 6). As shown in FIGS. 6 and 7, a coil end 14 is bound across its entire circumference by the binding wire 25 whereby the shape of the coil end 14 is held. The binding wire 25, like the clips 16 of the first embodiment, is covered over its circumference by an insulation coating 17 (FIG. 4) and is insulated from the coil end 14. The end portion of the binding wire 25 is connected to a signal wire 152 for measuring the resistance.

In the second embodiment as well, the signal from the binding wire 25 is input through the signal wire 152 and terminal box 102 to the control device 200. The control device 200 measures the resistance of the binding wire 25 by the resistance measuring part 202, and calculates the temperature of the winding wire 13 by the temperature calculating part 203 based on the measured resistance value. For this reason, there is no need to provide new space for measuring the temperature of the winding wire 13 at the stator 1, so it is possible to simplify the configuration of the electric motor 100. Further, the binding wire 25 is provided over the entire circumference of the coil end 14, so the control device 200 can calculate the approximately average temperature of the whole of the winding wire 13.

### Modification

In the first embodiment, although the resistance of a single clip 16 is measured, it is also possible to measure the resistances of a plurality of clips 16 by the resistance measuring part 202 and use the average value of these as the resistance value of the clips 16 to calculate the temperature of the winding wire 13 by the temperature calculating part 203. In the above embodiment, although the coil ends 14 are held by the electroconductive plurality of clips 16 or binding wires 25, the holding members are not limited to this configuration. For example, the plurality of clips 16 in the circumferential direction may be connected with each other or holding members may be used to cover the whole of the coil ends 14.

Although an ohmmeter is used to measure the resistance of a holding member, the resistance measuring part 202 is not limited to this in configuration. For example, it is also possible to determine in advance the relationship between the current which flows through the holding member and the resistance value and use this relationship to calculate the resistance value from the detected value of the current. The resistance measuring part 202 and the temperature calculating part 203 may be provided not in the control device 200, but at the electric motor 100 itself which has the stator 1 and the rotor 2. The control device 200 may also be configured as part of the electric motor 100.

The electric motor 100 of the present invention can be applied to a robot, machine tool, or various other machinery. If applying the electric motor 100 to a machine tool, it is possible to configure the control device 200 as part of a numerical control device.

The above embodiments can be freely combined with one or more of the modifications.

According to the present embodiments, the resistance of a holding member at a coil end is measured and the temperature of the winding wire is determined based on the measured value of that resistance, so there is no need to provide new space in the stator for measuring the temperature of the winding wire and the electric motor can be simplified in configuration.

While the present invention has been described with reference to the preferred embodiments thereof, those skilled in the art would understand that various modifications and changes may be made thereto without departing from the scope of the appended claims.

1. A temperature measuring system of an electric motor, comprising:
an electroconductive holding member holding a coil end of an end of a stator coil comprised of a winding wire wound around a stator core;
a resistance measuring part measuring a resistance of the holding member; and
a temperature calculating part calculating a temperature of the winding wire based on a resistance value measured by the resistance measuring part.

2. The temperature measuring system of an electric motor according to claim 1, wherein
the holding member is a binding wire binding the coil end.

3. The temperature measuring system of an electric motor according to claim 1, wherein
the holding member has an insulation coating around the holding member.

4. An electric motor comprising, a temperature measuring system of an electric motor according to claim 1.

5. A temperature measurement method of an electric motor comprising;
holding a coil end of an end of a stator coil comprised of a winding wire wound around a stator core, by an electroconductive holding member;
measuring a resistance of the holding member; and
calculating a temperature of the winding wire based on a measured resistance value.
